(19) United States
(12) Patent Application Publication
(10) Pub. No.: US 2026/0234751 A1
(43) Pub. Date: Aug. 13, 2026

(54) METHODS AND SYSTEMS FOR LEACHING A METAL-BEARING MATERIAL USING ALKYL THIOSULFONATES

(71) Applicant: FREEPORT MINERALS CORPORATION, Phoenix, AZ (US)

(72) Inventors: Chase Zenner, Tucson, AZ (US); Mitchell Catling, Tucson, AZ (US); Margaret Grabnic, San Francisco, CA (US); Ethan Bailly, Safford, AZ (US); James Jackman, Chandler, AZ (US); Matej Macak, London (GB); Eesha Khare, Saratoga, CA (US); Andrew Bendelsmith, Long Island City, NY (US); Lisa Awaitey, Quincy, MA (US)

(73) Assignee: FREEPORT MINERALS CORPORATION, Phoenix, AZ (US)

(21) Appl. No.: 19/537,824

(22) Filed: Feb. 12, 2026

Related U.S. Application Data
(60) Provisional application No. 63/757,656, filed on Feb. 12, 2025.
(60) Provisional application No. 63/873,221, filed on Aug. 29, 2025.

(51) Int. Cl. C22B 15/00; C22B 1/14; C22B 3/16

(52) U.S. Cl. CPC C22B 15/0065; C22B 1/14; C22B 3/1616

(57) ABSTRACT

A method for leaching a metal-bearing material. The method comprises leaching the metal-bearing material with a leaching solution to produce a pregnant leaching solution, wherein the leaching solution comprises a raffinate and an alkyl thiosulfonate compound, wherein the alkyl thiosulfonate compound undergoes decomposition in the leaching system, and wherein the decomposition of the alkyl thiosulfonate compound lowers oxidation-reduction potential of the leaching system, improving recovery of a metal value from the metal-bearing material.

### CROSS-REFERENCE TO RELATED APPLICATIONS

This application claims priority to and the benefit of U.S. Provisional Patent Application No. 63/757,656 filed Feb. 12, 2025, entitled “Methods and Systems for Leaching a Metal-Bearing Material Using Alkyl Thiosulfonates,” and U.S. Provisional Patent Application No. 63/873,221 filed Aug. 29, 2025, entitled “Methods and Systems for Leaching a Metal-Bearing Material Using Alkyl Thiosulfonates,” the disclosures of which are incorporated herein by reference in their entireties for all purposes.

### FIELD OF INVENTION

The present invention generally relates to methods and systems for recovering metal values from metal-bearing materials and, more specifically, to leaching methods and systems using alkyl thiosulfonates.

### BACKGROUND

Heap leaching provides a low-cost method of extracting metal values from relatively low-grade metal-bearing materials and has found particular application in the processing of metal-bearing ores. Generally, in traditional heap leaching operations, an ore is mined, crushed, and then transported to a heap location where it is stacked onto an impervious pad. In some operations, the crushed ore goes through a particle size enhancement process called agglomeration to improve leaching efficiency before it is transported to the heap. A suitable solution is dispensed onto the heap, and the resulting leach solution trickles slowly through the heap under the force of gravity to the pad. This pad typically has a sloped base to allow the solution to flow into collection drains for further processing, such as by a conventional, solvent extraction/electrowinning (SX/EW) process or a direct electrowinning (DEW) process.

Once ores have been subject to the energy intensive processes of blasting, crushing, and agglomeration, a high percentage of the contained valuable metal can be extracted by existing leaching methods. While these methods are relatively effective at metal extraction, implementing improvements to traditional processing techniques to increase extraction efficiency is economically advantageous. An improvement of leaching efficiency based on existing leaching methods may entail using reagents other than acids in the leaching process. Various additives have been suggested for use in the leaching process, however many result in operational issues, such as impacting downstream processes. For example, the use of iron in copper leaching is well known to improve the recovery of certain ore bodies, however, iron easily precipitates out of solution, causing permeability issues within the heap. Further, iron impurities within an electrowinning solution can damage electrowinning equipment (e.g. corrosion of cathode or anode plates) and/or decrease the final grade of the plated copper. Introducing alkyl thiosulfonate compounds to the leaching process results in increased leaching efficiency with no impact on downstream processes.

### SUMMARY

Disclosed herein is a system for leaching a metal-bearing material, comprising a leaching system comprising, a metal-bearing material and a leaching solution comprising a raffinate and an alkyl thiosulfonate compound. The leaching system is configured to leach the metal-bearing material to produce a pregnant leaching solution. The alkyl thiosulfonate compound undergoes decomposition in the leaching system, and the decomposing of the alkyl thiosulfonate compound lowers oxidation-reduction potential of the leaching system, improving recovery of a metal value from the metal-bearing material. In various embodiments, the lowered oxidation reduction potential of the leaching system reduces passivation film formation on the metal-bearing material.

In various embodiments of the invention, the alkyl thiosulfonate compound is sodium methanethiosulfonate (SMTS), and SMTS concentration in the leaching solution is about 0.05 g/L to about 1 g/L.

In various embodiments of the invention, the alkyl thiosulfonate compound is sodium ethanethiosulfonate, s-methyl methanethiosulfonate, s-tert-butyl methanethiosulfonate, or other alkyl thiosulfonates.

In various embodiments of the invention, the metal bearing material comprises primary or secondary sulfides.

In various embodiments of the invention, the intermediary decomposition product lowers cumulative net acid consumption of the leaching system, reducing overall external acid additions to maintain leaching conditions for the sulfide.

In various embodiments of the invention, the leaching system is a heap leaching system, or a subsurface leaching system. In various embodiments of the invention, the metal value is copper.

Disclosed herein is a method for leaching a metal-bearing material, comprising leaching the metal-bearing material with a leaching solution to produce a pregnant leaching solution, wherein the leaching solution comprises a raffinate and an alkyl thiosulfonate compound, wherein the alkyl thiosulfonate compound undergoes decomposition in the leaching system, and wherein the decomposition of the alkyl thiosulfonate compound lowers oxidation-reduction potential of the leaching system, improving recovery of a metal value from the metal-bearing material.

In various embodiments of the invention the intermediary decomposition product lowers cumulative net acid consumption of the leaching system.

In various embodiments of the invention, the alkyl thiosulfonate compound is sodium methanethiosulfonate (SMTS) or a salt thereof. In various embodiments of the invention, the SMTS concentration in the leaching solution is about 0.05 g/L to about 0.1 g/L. In various embodiments of the invention, the alkyl thiosulfonate compound is sodium ethanethiosulfonate, s-methyl methanethiosulfonate, s-tert-butyl methanethiosulfonate, or other alkyl thiosulfonates.

In various embodiments of the invention, the method further comprises agglomerating the metal-bearing material before the step of leaching.

In various embodiments of the invention, the method further comprises recovering the metal value from the pregnant leaching solution.

Disclosed herein is a method for leaching a metal-bearing material, comprising agglomerating the metal-bearing material with an agglomeration solution to form an agglomerated metal-bearing material, wherein the metal-bearing material is combined with a raffinate and an alkyl thiosulfonate compound to form the agglomeration solution, and leaching the agglomerated metal-bearing material with a leaching solution, wherein the alkyl thiosulfonate compound undergoes decomposition during the leaching, and wherein the decomposition of the alkyl thiosulfonate compound lowers oxidation reduction potential of the leaching system, improving recovery of a metal value from the metal-bearing material.

### BRIEF DESCRIPTION OF THE DRAWINGS

The subject matter of the present invention is particularly pointed out and distinctly claimed in the concluding portion of the specification. A more complete understanding of the present invention, however, may best be obtained by referring to the detailed description and claims when considered in connection with the drawing figures, wherein like numerals denote like elements and wherein:

FIG. 1 is a flow diagram illustrating a leaching method in accordance with various embodiments of the present invention.

FIG. 2 is a line graph showing the oxidation-reduction potential of a leaching operation under various operational conditions.

FIG. 3 is a line graph showing the copper recovery of various leaching systems in accordance with various embodiments of the present invention.

FIG. 4 is a line graph showing the total copper recovery using the indicated concentration of SMTS in the leaching raffinate.

FIG. 5 is a line graph showing the oxidation-reduction potential (ORP) using the indicated concentration of SMTS in the leaching raffinate.

FIG. 6 is a line graph showing cumulative net acid consumption using the indicated concentration of SMTS in the leaching raffinate.

FIG. 7 is a line graph showing the cumulative net acid reduction of various leaching systems in accordance with various embodiments of the present invention.

### DETAILED DESCRIPTION OF EXEMPLARY EMBODIMENTS

The following description is merely exemplary in nature and is not intended to limit the present invention, its applications, or its uses. It should be understood that throughout the drawings, corresponding reference numerals indicate like or corresponding parts and features. The description of specific examples indicated in various embodiments of the present invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features.

Furthermore, the detailed description of various embodiments herein makes reference to the accompanying drawing figures, which show various embodiments by way of illustration. While the embodiments are described in sufficient detail to enable those skilled in the art to practice the invention, it should be understood that other embodiments may be realized and that logical and mechanical changes may be made without departing from the spirit and scope of the present invention. Thus, the detailed description herein is presented for purposes of illustration only and not of limitation. For example, steps or functions recited in descriptions of any method, system, or process may be executed in any order and are not limited to the order presented. Moreover, any of the steps or functions thereof may be outsourced to or performed by one or more third parties. Furthermore, any reference to singular includes plural embodiments, and any reference to more than one component may include a singular embodiment.

The present invention generally relates to methods and systems for recovering metal values from metal-bearing materials and, more specifically, to leaching methods and systems using alkyl thiosulfonate compounds. Various embodiments of the present invention provide a method for recovering metal values through leaching the metal-bearing material with a leaching solution to produce a pregnant leaching solution, wherein the leaching solution comprises a raffinate and an alkyl thiosulfonate compound, wherein the alkyl thiosulfonate compound undergoes decomposition in the leaching system, and wherein the decomposition of the alkyl thiosulfonate compound lowers oxidation-reduction potential of the leaching system, improving recovery of a metal value from the metal-bearing material. In accordance with the various embodiments of the present invention, the disclosed process increases metal value yield compared with conventional methods and systems. Other advantages and benefits of the various embodiments of the present invention include that the disclosed process has no impact on downstream processes.

In accordance with an exemplary embodiment of the present invention, a method for recovering a metal value from a metal-bearing material includes the steps of leaching a metal-bearing material, comprising leaching the metal-bearing material with a leaching solution to produce a pregnant leaching solution, wherein the leaching solution comprises a raffinate and an alkyl thiosulfonate compound, wherein the alkyl thiosulfonate compound undergoes decomposition in the leaching system, and wherein the decomposition of the alkyl thiosulfonate compound lowers oxidation-reduction potential of the leaching system, improving recovery of a metal value from the metal-bearing material.

In another exemplary embodiment, a system for recovering a metal value from a metal-bearing material includes a leaching system comprising the metal-bearing material and a leaching solution comprising a raffinate and an alkyl thiosulfonate compound. The leaching system is configured to leach the metal-bearing material to produce a pregnant leaching solution. The alkyl thiosulfonate compound undergoes decomposition in the leaching system, and the decomposition of the alkyl thiosulfonate compound lowers oxidation-reduction potential of the leaching system, improving recovery of a metal value from the metal-bearing material.

Examples of metal values include, but are not limited to, copper, nickel, zinc, silver, gold, germanium, lead, arsenic, antimony, chromium, molybdenum, rhenium, tungsten, iron, ruthenium, osmium, cobalt, rhodium, iridium, palladium, platinum, uranium, or rare earth metals. More preferably, the metal values can be copper, nickel, and/or zinc. Most preferably, the metal value is copper.

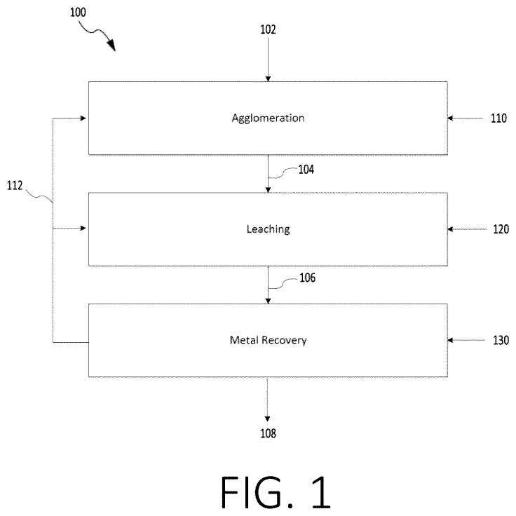

Referring now to FIG. 1, a metal leaching method 100 is illustrated according to various embodiments of the present invention. In accordance with various aspects of the embodiments, a metal-bearing material 102 may be provided for processing from which copper and/or other metal values may be recovered. The metal-bearing material 102 may be an ore, a concentrate, a process residue, or any other material from which metal values may be recovered. Metal values, such as those described herein, may be recovered from the metal-bearing material 102. In an aspect of the present invention, the metal-bearing material 102 may comprise a refractory metal sulfide.

In accordance with various embodiments, the metal-bearing material 102 may comprise chalcocite, pyrite, chalcopyrite, arsenopyrite, bornite, covellite, digenite, cobaltite, enargite, galena, greenockite, millerite, molybdenite, orpiment, pentlandite, pyrrhotite, sphalerite, stibnite, and/or any other suitable metal-bearing ore material. Preferably, the metal-bearing material 102 may comprise primary or secondary sulfides such as chalcocite, bornite, pyrite, covellite, or chalcopyrite, or a blend of such mineral species.

Various aspects and embodiments of the present invention, however, prove especially advantageous in connection with the recovery of copper from copper sulfide ores, such as, for example, chalcopyrite (CuFeS₂), chalcocite (Cu₂S), bornite (CusFeS₄), covellite (CuS), enargite (Cu₃AsS₄), digenite (Cu₉S₅), and mixtures thereof. Thus, the metal-bearing material 102 may be a copper ore or concentrate, and preferably, is a copper sulfide ore or concentrate.

The metal-bearing material 102 may comprise ore in a number of states. Before an ore deposit is mined, the ore is said to be in an in-situ state. During mining, the metal-bearing material 102 may progress through multiple states as it is harvested, collected, transported, and processed. For example, the metal-bearing material 102 as harvested at the mining site may often be referred to as run of mine (or “ROM”) ore. ROM ore may be produced by, for example, blasting, open pit mining, and other surface and subterranean ore extraction techniques. As such, ROM ore includes ore of various sizes from ore as small as powder up to and including boulders.

In an aspect of the present invention, all or a portion of the metal-bearing material 102 may be further processed via size classification and/or crushing to achieve a desired particle size distribution, such that, substantially all of the particles are of a size to allow effective agglomeration of the metal-bearing material 102 and allow for optimal economic recovery of the contained metal values.

In accordance with various embodiments of the present invention, the metal-bearing material 102 has a particle distribution of any combination of particle distributions. The particle distribution may have a combination of fine and coarse particles. Any particle distribution that maximizes agglomeration and/or curing, and metal recovery is useful. The conditions and parameters of the metal leaching method 100 disclosed herein may be adjusted to achieve an optimized result for leaching and metal recovery.

In accordance with various embodiments, the metal-bearing material 102 may be subjected to an agglomerating process 110 to produce an agglomerated metal-bearing material 104. In various embodiments, the agglomerating process 110 may include applying an agglomeration solution to the metal-bearing material 102. In various embodiments, the agglomeration solution may include a raffinate 112 and an alkyl thiosulfonate compound. In various embodiments, the agglomerating process 110 may combine the metal-bearing material 102 with the agglomeration solution to form the agglomerated metal-bearing material 104. In various embodiments, the agglomerating process 110 may cure the metal-bearing material 102 in the agglomeration solution to form a cured metal-bearing material. In various embodiments, curing may render the metal-bearing material 102 amenable to a subsequent leaching process.

As will be appreciated by those skilled in the art, the raffinate 112 and the alkyl thiosulfonate compound may be mixed prior to combination with the metal-bearing material 102, such that the agglomeration solution comprises raffinate 112 and a dissolved concentration of the alkyl thiosulfonate compound which is then applied to the metal-bearing material 102. In other embodiments, the raffinate 112 and the alkyl thiosulfonate compound may be combined with the metal-bearing material 102 separately, such that the agglomeration solution comprises raffinate 112 and is combined with the metal-bearing material 102. After the metal-bearing material 102 has rested in the agglomeration solution for a period of time sufficient to optimize agglomeration and metal recovery and form the agglomerated metal-bearing material, the alkyl thiosulfonate compound may be added to the agglomerated metal-bearing material. The alkyl thiosulfonate compound may be added in any form suitable for combining with the agglomerated metal-bearing material. By way of nonlimiting example, the alkyl thiosulfonate compound may be added in solid form, such as a powder, or liquid form.

In various embodiments, the order of application of the raffinate 112 and alkyl thiosulfonate compound addition may be reversed, such that the alkyl thiosulfonate compound is combined with the metal-bearing material 102 first to form an alkyl thiosulfonate compound enhanced metal-bearing material, to which the raffinate 112 is applied. In various embodiments, a raffinate provided from any other metal recovery process (not shown) may be used to form the agglomerated metal-bearing material 104. In various embodiments, the raffinate 112 may be an aqueous product of a solvent extraction process, such as, for example, a conventional solvent extraction/electrowinning (SX/EW) process, a direct electrowinning (DEW) process, an ion-exchange (IX) process, and/or a precipitation process. In various embodiments, the raffinate 112 may comprise water and acid. In various embodiments, the raffinate 112 may comprise a concentrated acid only.

In an aspect of the invention, the agglomerating process 110 may involve the metal-bearing material 102 being combined with the raffinate 112 and the alkyl thiosulfonate compound in an agglomeration drum. An agglomeration drum may be any suitable agglomeration drum known in the art. In accordance with an exemplary embodiment, the raffinate 112 and alkyl thiosulfonate compound may be combined with the metal-bearing material 102 within the agglomeration drum. The quantity of the raffinate 112 and the quantity of the alkyl thiosulfonate compound in the agglomeration solution may vary with respect to the type and/or quantity of metal-bearing material 102 used. In this regard, the raffinate 112 may be mixed with a certain quantity of the alkyl thiosulfonate compound to form an agglomeration solution and the agglomeration solution may be optimized during the agglomerating process 110. The metal-bearing material 102 is mixed with the raffinate 112 and alkyl thiosulfonate compound in the agglomeration drum to produce the agglomerated metal-bearing material 104. The agglomerating process 110 may include the blending of coarse portions and fine portions of the metal-bearing material 102, in order to maximize metal recovery while maintaining heap permeability in heap leaching.

In an aspect of the invention, the agglomeration solution may include a certain concentration of alkyl thiosulfonate compound. In various embodiments, the concentration of the alkyl thiosulfonate compound in the agglomeration solution may be adjusted to achieve an optimized result for agglomeration and metal recovery.

In an aspect of the invention, the agglomerating process 110 may comprise resting the metal-bearing material 102 in the agglomeration solution for a certain period of time. In various embodiments, the certain period of time may be adjusted to achieve an optimized result for agglomeration and metal recovery. In various embodiments, the metal-bearing material 102 may rest in the agglomeration solution for any duration in the range of about 0 to about 8 days. In various embodiments, the metal-bearing material 102 may rest in the agglomeration solution for any duration in the range of about 0 to about 40 days. In various embodiments, the metal-bearing material 102 may rest in the agglomeration solution for any duration on the order of at least 1 day. In an aspect of the invention, the agglomerated metal-bearing material 104 may be subjected to a leaching process 120 to produce a pregnant leaching solution 106.

In other embodiments, the metal-bearing material 102 may bypass the agglomerating process 110 and proceed directly to the leaching process 120, such that a leaching solution is applied to the metal-bearing material 102 to produce pregnant leaching solution 106. In various embodiments, the leaching solution used in the leaching process 120 may comprise the raffinate 112. In various embodiments, the leaching solution may comprise water and acid. In various embodiments, the leaching solution may further comprise the alkyl thiosulfonate compound. In various embodiments, the concentration of the alkyl thiosulfonate compound in the leaching solution may be in the range of about 0.025 g/L to about 10 g/L, preferably in the range of about 0.05 g/L to about 5 g/L, more preferably about 0.2 g/L to about 3 g/L, more preferably about 0.1 g/L to 1 g/L.

In an aspect of the invention, the leaching process 120 may comprise applying the leaching solution to the metal-bearing material 102 and resting the metal-bearing material 102 in the leaching solution for a certain period of time. In various embodiments, the certain period of time may be adjusted to achieve an optimized result for leaching and metal recovery. In various embodiments, the metal-bearing material 102 may rest in the leaching solution for any duration in the range of about 0 to about 40 days. In various embodiments, the metal-bearing material 102 may rest in the leaching solution for any duration in the range of about 0 to about 15 days. In various embodiments, the metal-bearing material 102 may rest in the leaching solution for any duration on the order of at least 1 day.

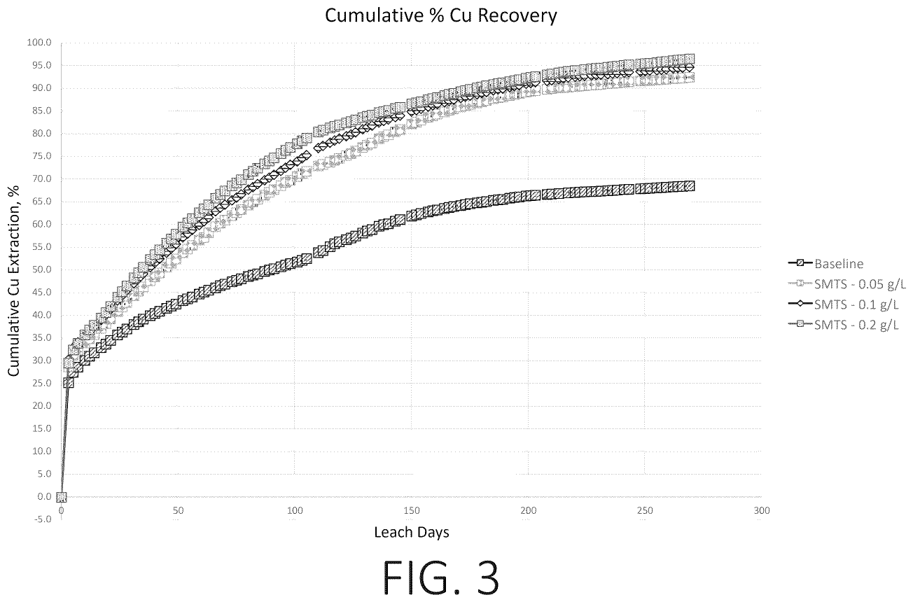

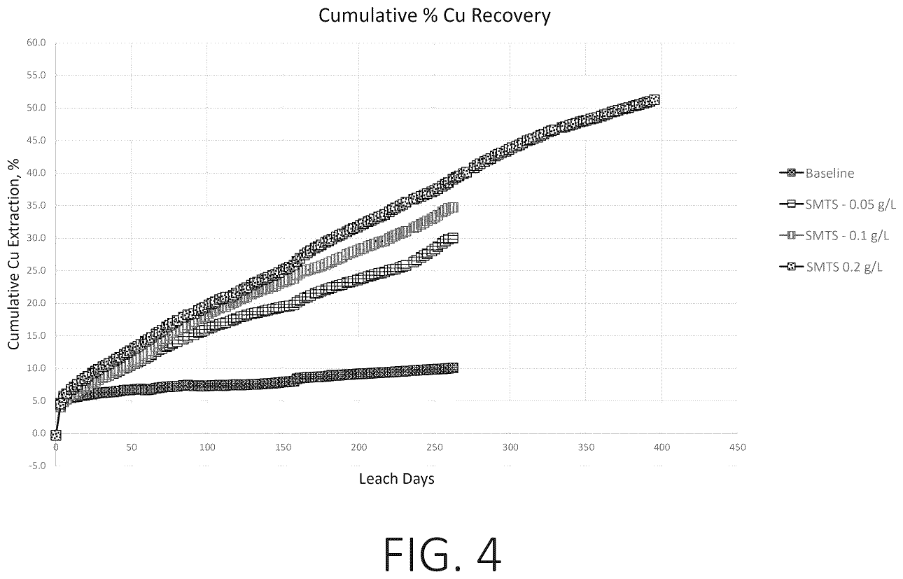

In various embodiments, the alkyl thiosulfonate compound may improve recovery of the metal-bearing material 102. As can be seen in FIG. 3 and FIG. 4, copper recovery may improve as the concentration of SMTS increases. While not being bound by any particular theory, the alkyl thiosulfonate compound may improve recovery of the metal-bearing material 102 by one or more of several mechanisms. In various embodiments, the mechanisms discussed below may operate alone or in tandem, and a leaching process may comprise any number of operative recovery improvement mechanisms at a time. In various embodiments, the alkyl thiosulfonate compound may comprise any alkyl thiosulfonate compound suitable for leaching a metal-bearing material 102. In various embodiments, the alkyl thiosulfonate compound may comprise sodium methanethiosulfonate (SMTS). In various embodiments, SMTS comprises a sulfur-sulfur bond which may contribute to the performance of the compound for improving metal recoveries from pregnant leach solution.

In various other embodiments, the alkyl thiosulfonate compound may comprise S-methyl methanethiosulfonate, S-sodium ethanethiosulfonate, S-tert-butyl methanesulfonothionate, and the like, and/or mixtures thereof. In such embodiments, the concentration of the alkyl thiosulfonate compound may be in the range of about 0.025 g/L to about 10 g/L, preferably in the range of about 0.05 g/L to about 5 g/L, more preferably about 0.2 g/L to about 3 g/L, more preferably about 0.1 g/L to 1 g/L.

In various embodiments, SMTS may decompose into methanesulfonic acid (MSA), or another alkyl thiosulfonate may decompose into its corresponding alkyl sulfonic acid during the leaching process 120. In various embodiments, the decomposition may produce sulfur dioxide (SO₂), which is generated at the surface of minerals within the metal-bearing material 102. While not being bound to any particular theory, this decomposition process comprising the intermediary step of SO₂ production may generate reducing conditions in a localized area, which have been found to be beneficial in sulfide leaching and finding particular use in chalcopyrite leaching.

Additionally, a common issue in metal leaching is passivation, wherein an unreactive layer of material (e.g., sulfur) forms over the mineral surface within the metal-bearing material 102, preventing a leaching solution from reaching the metal value contained within and preventing the liberation of the metal value. While not being bound to any particular theory, SMTS comprises a sulfur-sulfur bond that is weak and redox reactive, and it is possible that this bond enables the breaking up of sulfur-based unreactive layers through redox chemistry or direct bond formation and breaking with the unreactive layer. Sulfur is a common unreactive layer, therefore, it is possible that by using sulfur in various chemical processes, such as those with SMTS or another alkyl thiosulfonate compound, the mineral surface within the metal-bearing material 102 is exposed, allowing the leaching solution to reach and liberate the metal value.

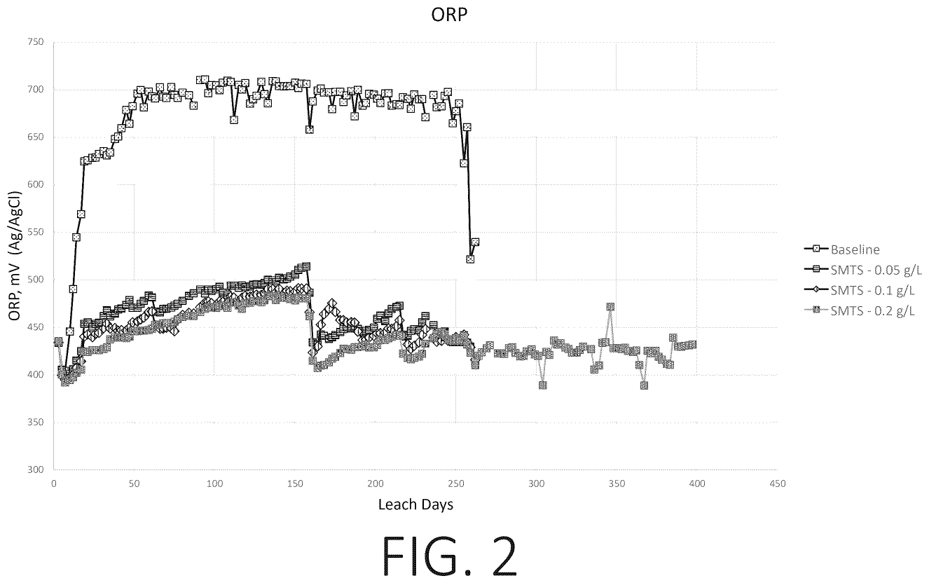

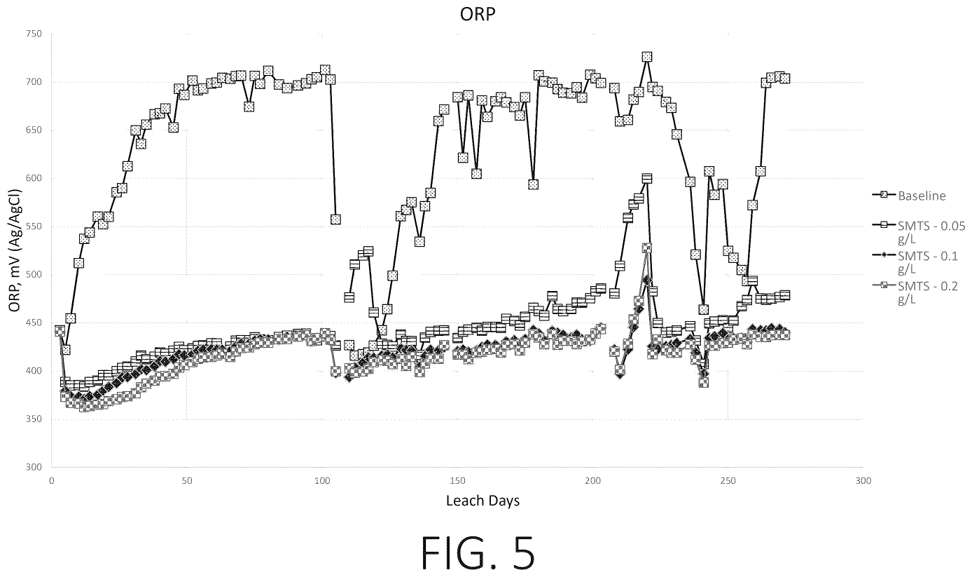

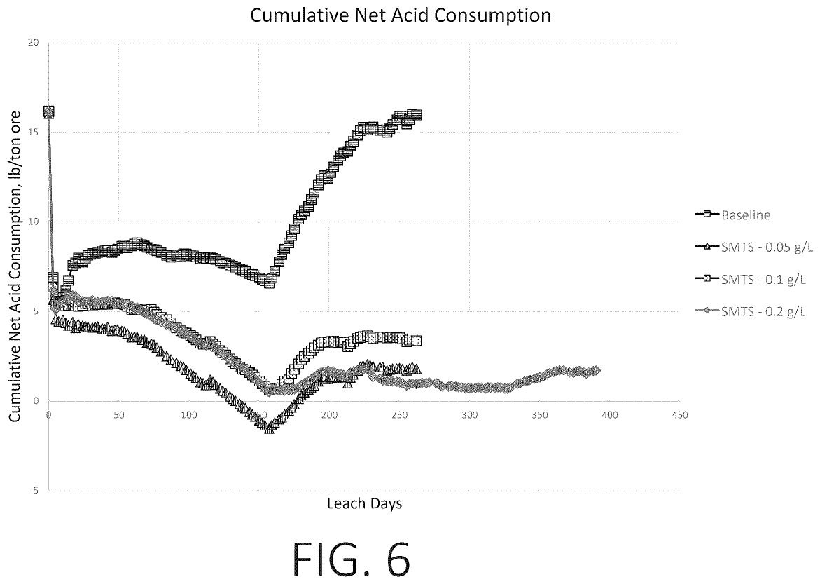

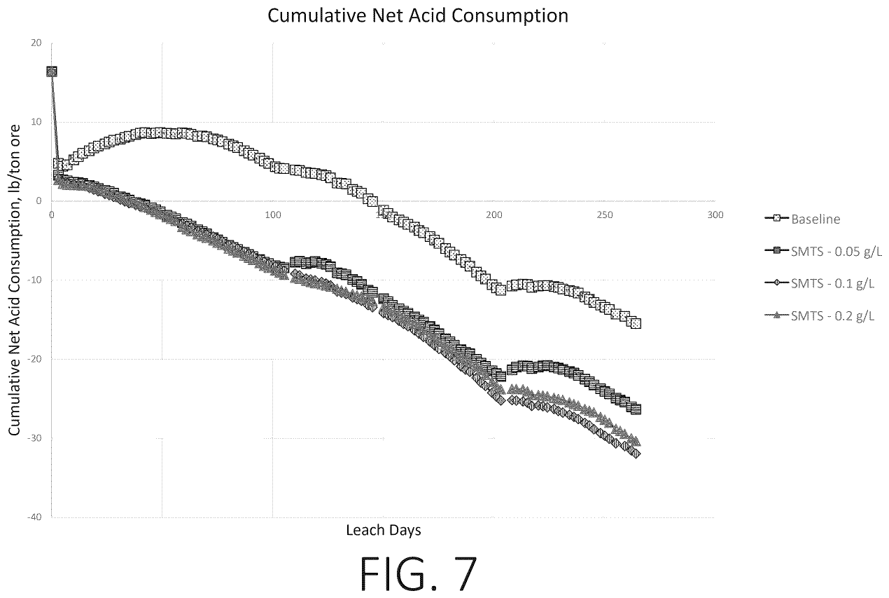

In various embodiments, SMTS or other alkyl thiosulfonate compounds may help lower the oxidation-reduction potential (ORP) of the leaching process and maintain the ORP within a lower range, allowing operators greater control over the conditions within the heap. Throughout the leaching process, ORP naturally increases as ferric ions are produced, and, too high of an ORP may inhibit leaching and recovery and lead to increased acid consumption. As can be seen in FIG. 2 and FIG. 5, SMTS may reduce and maintain the ORP within a lower range more effectively than leaching operations not including SMTS. As can be seen in FIG. 6 and FIG. 7, SMTS may in turn decrease acid consumption in comparison to leaching operations not including SMTS.

In an aspect of the invention, the leaching process 120 may comprise heap leaching. In various embodiments, the heap leaching may comprise stacking or forming the agglomerated metal-bearing material 104 into a heap or a portion of a heap. In various embodiments, the heap leaching may comprise leaching the heap with the leaching solution after the heap is formed. In various embodiments, the irrigation rate of the leaching solution onto the heap may be reduced during the initial phase of leaching to improve initial recoveries. While not being bound by any particular theory, reduced irrigation rates may enable the alkyl thiosulfonate compound and its associated decomposition products, such as, for example, a sulfonyl radical and/or an alkyl radical, to react directly at the surface of the ore, rather than within the leaching solution. Reactions at the ore surface improve the exposure of the mineral surface from passivating layers, improving the ability of the leaching solution to contact the mineral surface and extract targeted metals. In an aspect of the invention, the alkyl thiosulfonate compounds may be particularly beneficial in agitate leaching applications. It is also possible that reduced irrigation rates may favor competitive decomposition, thereby reducing productive chemistry at the ore surface.

In another aspect of the invention, the leaching process 120 may comprise any other known leaching method, such as column leaching, shake flask leaching, or tank/agitation leaching. In accordance with one aspect of the present invention, the leach process 120 comprises atmospheric leaching, pressure leaching, whole ore leaching, agitation leaching, heap leaching, stockpile leaching, pad leaching, thin-layer leaching and/or vat leaching, at either ambient or elevated temperatures.

In various embodiments, a system for delivering the leaching solution may generally comprise one or more pipes arranged to deposit leaching solution to the heap, column, tank, flask, or vat (whichever means is used to collect a metal-bearing material). The leaching solution distribution system may be configured in a network arrangement to receive leaching solution from one or more sources and conduct the leaching solution to the metal-bearing material. The leaching solution may be sourced from a variety of locations. Fresh acid and/or water may be used as well as acid and/or water that is recycled or reclaimed from other metal value recovery process, such as raffinate from a solvent extraction/electrowinning (“SXEW”) process. In various embodiments, fresh basic medium and/or water may be used as well as basic medium and/or water that is recycled or reclaimed from other metal value recovery processes. In various embodiments, the leach solution may be enhanced with specific strains of bacteria, air, enriched air, oxygen, chemical oxidants, and/or leach enhancing chemicals. The leaching solution distribution system may be provided these sources of leaching solution and distribute them to the metal-bearing material.

In various embodiments, the metal bearing materials contain oxides, for example, oxides of metal values. For example, copper and cobalt oxides. In various embodiments, electrowinning may comprise an anode configured to enable the electrolyte to flow through it. As used herein, the term “flow-through anode” refers to an anode so configured.

In accordance with various embodiments in which the metal-bearing material is positioned in a heap, the leaching process 120 may comprise a subsurface leaching system. In several embodiments, the subsurface leaching system may comprise one or more subsurface injectors. Subsurface injectors may comprise any suitable structure configured to deliver leaching solution at a target operational condition beneath the surface of a heap. In various embodiments, the subsurface leaching system may comprise a first subsurface injector, a second subsurface injector, a third subsurface injector, a fourth subsurface injector, and a fifth subsurface injector, etc. The subsurface leaching system may also suitably comprise more or less than five subsurface injectors, in various embodiments. Subsurface injectors may be fluidly coupled to a primary pipe and/or secondary pipe to receive leaching solution and distribute the leaching solution to desired locations within the heap. Additional information regarding subsurface injection may be found in U.S. Pat. No. 12,378,634, the entire contents of which is incorporated by reference herein.

In various embodiments, the leaching process 120 may comprise an agitated tank leach. The agitated tank leach may be performed at constant or varying pH levels. Basic pH levels may range from about 7 to about 14. Leach solutions may contain recycled solutions from upstream processes and recovered lixiviant from various processing steps. Fresh lixiviant may also be added. Leaching may occur in several tanks, either co-currently or counter-currently depending on the leach characteristics and kinetics. Preferably, the duration of leaching in accordance with various aspects of the present invention ranges from about 2 hours to about 8 hours. More preferably, the duration ranges from about 4 hours to about 7 hours.

In an aspect of the invention, the pregnant leaching solution 106 may be subjected to a metal recovery process 130 to produce the metal value 108 and the raffinate 112. In various embodiments, the metal recovery process 130 may comprise a direct electrowinning (DEW) process. In another exemplary embodiment, the metal recovery process 130 may comprise a solvent extraction and electrowinning (SX/EW) process.

In various embodiments, the raffinate 112 may be recirculated and reused in the metal leaching method 100. In various embodiments, the raffinate 112 may be reused in the agglomerating process 110 as a component of the agglomeration solution. In various embodiments, the raffinate 112 may be reused in the leaching process 120 as a component of the leaching solution.

In an aspect of the invention, part or all of the metal leaching method 100 may be carried out under a certain pressure and temperature. In various embodiments, the agglomerating process 110, leaching process 120, and metal recovery process 130 may be carried out under a certain pressure and temperature. In various embodiments, the pressure and/or temperature may be adjusted to achieve an optimized result for agglomeration, leaching, and/or metal recovery. In various embodiments, leaching method 100 may be carried out at ambient temperatures, such as, for example, in an autoclave leaching process.

In various embodiments, the agglomerating process 110, leaching process 120, and/or metal recovery process 130 may be carried out under an atmospheric pressure. In various embodiments, the agglomerating process 110, leaching process 120, and/or metal recovery process 130 may be carried out under another pressure. In various embodiments, the agglomerating process 110, leaching process 120, and/or metal recovery process 130 may be carried out under an ambient temperature, such as 20-22° C. In various embodiments, the agglomerating process 110, leaching process 120, and/or metal recovery process 130 may be carried out under another temperature, such as 0-60° C.

The Examples set forth herein are illustrative of exemplary embodiments of the present invention. The process, conditions and parameters reflected therein are intended to exemplify various aspects of the invention and are not intended to limit the scope of the claimed invention.

### Example 1

A specimen of copper-containing ore was subject to a leaching method disclosed in the present invention. The ore contained approximately 0.52% by weight of copper minerals, of which comprised the following concentrations: 37% of chalcopyrite, 35% of covellite, 15% of sulfates and/or silicates, 7% of muscovite, and 6% of other types of copper-bearing materials. Approximately 12 pounds of ore was combined with a raffinate and an alkyl thiosulfonate compound (sodium methanethiosulfonate (SMTS)) added at the concentrations shown in Table 1. The concentration of SMTS in raffinate was varied to show the impact of concentration on copper recovery. The combined ore was leached in a leaching column for 269 days under an atmospheric pressure at 20-22° C. to produce a pregnant leaching solution. The pregnant leach solution was collected from the ore through a drain on the bottom of the column and assayed to determine extracted metal concentration.

The following leaching trials were carried out, as listed in Table 1. Except those conditions and reagents described below and listed in Table 1, each leaching trial was conducted under the same conditions with the same reagents.

TABLE 1
Conditions and Cu Recovery Rates of Four Leaching Trials

| Trial No. | SMTS (g/L) | Cu Recovery (%) |
|---|---|---|
| 1 | 0 | 68.4 |
| 2 | 0.05 | 92.4 |
| 3 | 0.1 | 94.6 |
| 4 | 0.2 | 96.4 |

As can be seen in Table 1, and corresponding to FIG. 3, copper recovery improves with the addition of SMTS, with recoveries of around 28% higher than the trial containing only raffinate and no SMTS. This corresponds to a 40% increase in copper recovery.

### Example 2

A specimen of copper-containing ore was subject to a leaching method disclosed in the present invention. The ore contained approximately 0.13% by weight of copper minerals, of which comprised the following concentrations: 96% of chalcopyrite, 3% of covellite, and 1% of other types of copper-bearing materials. Approximately 12 pounds of ore was combined with a raffinate and SMTS was added at the concentrations shown in Table 2. The concentration of SMTS in raffinate was varied to show the impact of concentration on copper recovery. The combined ore was leached in a leaching column for 248 days under atmospheric pressure at 20-22° C. to produce a pregnant leaching solution. The pregnant leach solution was collected from the ore through a drain on the bottom of the column and assayed to determine extracted metal concentration.

The following leaching trials were carried out, as listed in Table 2. Except those conditions and reagents described below and listed in Table 2, each leaching trial was conducted under the same conditions with the same reagents (three replicates in each group).

TABLE 2
Conditions and Cu Recovery Rates of Four Leaching Trials

| Trial No. | SMTS (g/L) | Cu Recovery (%) |
|---|---|---|
| 1 | 0 | 9.8 |
| 2 | 0.05 | 28.0 |
| 3 | 0.1 | 32.9 |
| 4 | 0.2 | 37.1 |

As can be seen in Table 2, and corresponding to FIG. 4, copper recovery improves with the addition of SMTS, with recoveries of around 27% higher than the trial containing only raffinate and no SMTS. Even at the lowest concentration of SMTS, copper recovery was increased by over 15%. Additionally, as shown in FIG. 2 and FIG. 5, the addition of SMTS at any concentration resulted in a reduction in the oxidation-reduction potential, which helps to account for the enhanced copper recovery (as the ORP is lowered, passivation films may be less likely to form). As shown in FIG. 6 and FIG. 7, the addition of SMTS also reduces the cumulative net acid consumption, leading to more efficient leaching.

While not being bound by any particular theory or reaction process, the present inventors have found that low concentrations of SMTS can enhance copper recovery in heap leaching operations on a variety of levels, in surprising and unexpected ways. For example, the additions may reduce both ORP and enhance copper recovery, while minimizing net acid consumption, potentially demonstrating more efficient and cost-effective leaching efforts, as may hereafter be devised or developed in view of the teachings provided herein.

### Example 3

A specimen of copper-containing ore was subject to a leaching method disclosed in the present invention. The ore contained approximately 0.13% by weight of copper minerals, of which comprised the following concentrations: 96% of chalcopyrite, 3% of covellite, and 1% of other copper-bearing materials. Approximately 12 pounds of ore was combined with a raffinate and SMTS was added at the concentrations shown in Table 3. The concentration of SMTS in raffinate was varied to show the impact of concentration on the oxidation-reduction potential. The combined ore was leached in a leaching column for 262 days under atmospheric pressure at 20-22° C. to produce a pregnant leaching solution. The pregnant leach solution was collected from the ore through a drain on the bottom of the column, and the oxidation-reduction potential was measured.

The following leaching trials were carried out, as listed in Table 3. Except those conditions and reagents described below and listed in Table 3, each leaching trial was conducted under the same conditions with the same reagents.

TABLE 3
Conditions and ORP of Four Leaching Trials

| | | ORP (mV) |
|---|---|---|
| Trial No. | SMTS (g/L) | (Ag/AgCl) |
| 1 | 0 | 539.6 |
| 2 | 0.05 | 414.2 |
| 3 | 0.1 | 415.7 |
| 4 | 0.2 | 410.1 |

As can be seen in Table 3, and corresponding to FIG. 2, the oxidation-reduction potential decreases with the addition of SMTS, with an oxidation-reduction potential of around 129 mV lower than the trial containing only raffinate and no SMTS. Additionally, FIG. 5 shows a similar reduction in the oxidation-reduction potential with the addition of SMTS. As discussed above, as the ORP is lowered, passivation films may be less likely to form and copper recovery may be improved, potentially demonstrating more efficient and cost-effective leaching efforts.

### Example 4

A specimen of copper-containing ore was subject to a leaching method disclosed in the present invention. The ore contained approximately 0.52% by weight of copper minerals, of which comprised the following concentrations: 37% of chalcopyrite, 35% of covellite, 15% of sulfates and/or silicates, 7% of muscovite, and 6% of other copper-bearing materials. Approximately 12 pounds of ore was combined with a raffinate and SMTS was added at the concentrations shown in Table 3. The concentration of SMTS in raffinate was varied to show the impact of concentration on the net acid consumption. The combined ore was leached in a leaching column for 264 days under atmospheric pressure at 20-22° C. to produce a pregnant leaching solution. The pregnant leach solution was collected from the ore through a drain on the bottom of the column, and the net acid consumption was measured.

The following leaching trials were carried out, as listed in Table 3. Except those conditions and reagents described below and listed in Table 3, each leaching trial was conducted under the same conditions with the same reagents.

TABLE 4
Conditions and Cumulative Net Acid
Consumption of Four Leaching Trials

| | | Cumulative Net |
|---|---|---|
| | | Acid Consumption |
| Trial No. | SMTS (g/L) | (lb/ton ore) |
| 1 | 0 | −15.5 |
| 2 | 0.05 | −26.3 |
| 3 | 0.1 | −31.9 |
| 4 | 0.2 | −30.4 |

As can be seen in Table 4, and corresponding to FIG. 7, the cumulative net acid consumption decreases with the addition of SMTS, with a cumulative net acid consumption of around 14.9 lbs/ton ore lower than the trial containing only raffinate and no SMTS. Additionally, FIG. 6 shows a similar reduction in the cumulative net acid consumption with the addition of SMTS. As discussed above, the reduction in the cumulative net acid consumption may lead to more efficient and cost-effective leaching. Furthermore, certain metal-bearing materials, such as sulfides, may generate acid during the leaching process. When such minerals are processed in conjunction with SMTS, the generated acid may further reduce the amount of external additions of acid required to maintain the leaching conditions, thereby further enhancing overall leaching efficiency and cost-effectiveness.

### Example 5

A specimen of copper-containing ore was subject to a leaching method disclosed in the present invention. The ore contained approximately 0.13% by weight of copper minerals, of which comprised the following concentrations: 96% of chalcopyrite, 3% of covellite, and 1% of other types of copper-bearing materials. Approximately 12 pounds of ore was combined with a raffinate. In one trial, sodium ethanethiosulfonate (SETS) was added at a concentration of 0.5 g/L, and in a parallel trial, no SETS was added. The combined ore was leached in a leaching column for 112 days under atmospheric pressure at 20-22° C. to produce a pregnant leaching solution. The pregnant leach solution was collected from the ore through a drain on the bottom of the column and assayed to determine extracted metal concentration.

After 112 days of leaching, the trial containing SETS achieved an ultimate copper recovery of approximately 23.8%, representing an increase of approximately 12.4% compared to the trial containing only raffinate and no SETS, which showed a recovery of approximately 11.4%. Furthermore, the addition of SETS resulted in a reduction in the oxidation-reduction potential by approximately 246 mV, with the ORP decreasing from approximately 694 m V in the trial with no SETS to approximately 448 mV in the trial with SETS. The addition of SETS also reduced the cumulative net acid consumption, showing a decrease of around 2 lbs/ton ore, from −3.3 lbs/ton in the trial with no SETS to −1.3 lbs/ton in the trial containing SETS. These results demonstrate that multiple variants of alkyl thiosulfonate compounds are effective.

As discussed above, the present invention includes a metal leaching method utilizing alkyl thiosulfonate compounds to improve the efficiency of metal extraction operations. The present invention has been described with reference to various exemplary embodiments. However, many changes, combinations, and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other metal extraction processes. These and other changes or modifications are intended to be included within the scope of the present claims.

The present invention has been described above with reference to a number of exemplary embodiments. It should be appreciated that the particular embodiments shown and described herein are illustrative of the invention and its best mode and are not intended to limit in any way the scope of the invention as set forth in the claims. Those skilled in the art having read this disclosure will recognize that changes and modifications may be made to the exemplary embodiments without departing from the scope of the present invention. For example, various aspects and embodiments of this invention may be applied to recovery of metals other than copper, such as nickel, zinc, cobalt, and others. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

It is believed that the disclosure set forth above encompasses at least one distinct invention with independent utility. While the invention has been disclosed in the exemplary forms, the specific embodiments thereof as disclosed and illustrated herein are not to be considered in a limiting sense as numerous variations are possible. Equivalent changes, modifications and variations of various embodiments, materials, compositions, and methods may be made within the scope of the present invention, with substantially similar results. The subject matter of the inventions includes all novel and non-obvious combinations and sub combinations of the various elements, features, functions, and/or properties disclosed herein.

Benefits, other advantages, and solutions to problems have been described herein with regard to specific embodiments. However, the benefits, advantages, solutions to problems, and any element or combination of elements that may cause any benefit, advantage, or solution to occur or become more pronounced are not to be construed as critical, required, or essential features or elements of any or all the claims or the invention. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

What is claimed is:

1. A system for leaching a metal-bearing material, comprising:
a leaching system comprising:
the metal-bearing material; and
a leaching solution comprising a raffinate and an alkyl thiosulfonate compound;
wherein the leaching system is configured to leach the metal-bearing material to produce a pregnant leaching solution;
wherein the alkyl thiosulfonate compound undergoes decomposition in the leaching system, and wherein the decomposition of the alkyl thiosulfonate compound lowers oxidation reduction potential of the leaching system, improving recovery of a metal value from the metal-bearing material.

2. The system of claim 1, wherein lowered oxidation reduction potential of the leaching system reduces passivation film formation on the metal-bearing material.

3. The system of claim 1, wherein the alkyl thiosulfonate compound is sodium methanethiosulfonate (SMTS) or a salt thereof.

4. The system of claim 3, wherein the SMTS concentration in the leaching solution is about 0.05 g/L to about 1 g/L.

5. The system of claim 1, wherein the alkyl thiosulfonate compound is sodium ethanethiosulfonate or a salt thereof.

6. The system of claim 1, wherein the metal-bearing material comprises primary or secondary sulfides.

7. The system of claim 6, wherein the intermediary decomposition product lowers cumulative net acid consumption of the leaching system, reducing overall external acid additions to maintain leaching conditions for the sulfide.

8. The system of claim 1, wherein the leaching system is a heap leaching system.

9. The system of claim 1, wherein the leaching system is a subsurface leaching system.

10. The system of claim 1, wherein the metal value is copper.

11. A method for leaching a metal-bearing material, comprising:
leaching the metal-bearing material with a leaching solution to produce a pregnant leaching solution, wherein the leaching solution comprises a raffinate and an alkyl thiosulfonate compound,
wherein the alkyl thiosulfonate compound undergoes decomposition in the leaching system, and wherein the decomposition of the alkyl thiosulfonate compound lowers oxidation reduction potential of the leaching system, improving recovery of a metal value from the metal-bearing material.

12. The method of claim 11, wherein the intermediary decomposition product lowers cumulative net acid consumption of the leaching system.

13. The method of claim 11, wherein the alkyl thiosulfonate compound is sodium methanethiosulfonate (SMTS) or a salt thereof.

14. The method of claim 12, wherein the SMTS concentration in the leaching solution is about 0.05 g/L to about 1 g/L.

15. The method of claim 11, wherein the alkyl thiosulfonate compound is sodium ethanethiosulfonate or a salt thereof.

16. The method of claim 11, wherein the alkyl thiosulfonate compound is s-methyl methanethiosulfonate.

17. The method of claim 11, wherein the alkyl thiosulfonate compound is s-tert-butyl methanethiosulfonate.

18. The method of claim 11, further comprising agglomerating the metal-bearing material before the step of leaching.

19. The method of claim 11, further comprising recovering the metal value from the pregnant leaching solution.

20. A method for leaching a metal-bearing material, comprising:
agglomerating the metal-bearing material with an agglomeration solution to form an agglomerated metal-bearing material, wherein the metal-bearing material is combined with a raffinate and an alkyl thiosulfonate compound to form the agglomeration solution; and
leaching the agglomerated metal-bearing material with a leaching solution, wherein the alkyl thiosulfonate compound undergoes decomposition during the leaching, and wherein the decomposition of the alkyl thiosulfonate compound lowers oxidation reduction potential of the leaching system, improving recovery of a metal value from the metal-bearing material.
